(19) United States
(12) Patent Application Publication
(10) Pub. No.: US 2005/0105602 A1
(43) Pub. Date: May 19, 2005

(54) System and method for extended range digital subscriber line

(76) Inventors: Miguel Peeters, Mechelen (BE); Raphael Cassiers, Mechelen (BE); Olivier van de Wiel, Mechelen (BE)

Correspondence Address: STERNE, KESSLER, GOLDSTEIN & FOX PLLC, 1100 NEW YORK AVENUE, N.W., WASHINGTON, DC, 20005, US

(21) Appl. No.: 10/879,523

(22) Filed: Jun. 30, 2004

Related U.S. Application Data
(60) Provisional application No. 60/483,221, filed on Jun. 30, 2003.

(51) Int. Cl. H04B 1/38

(52) U.S. Cl. 375/222

(57) ABSTRACT

The present invention relates to a method and a system for transmitting data in a xDSL communication system increasing the range of the communication link. The communication system may consist of any two communication devices that are connected together by a band limited communication line. According to the present invention for transmitting data in a bidirectional digital subscriber line (xDSL) communication system the communication system comprises a first communication device and a second communication device, both communication devices being connected by a communication line, wherein the first communication device is adapted to send data in upstream direction over the communication line in an upstream frequency spectrum and the second communication device is adapted to send date in downstream direction over the communication line in a downstream frequency spectrum, both communication devices are adapted to receive the data in the send frequency spectrum of the other communication device, and between the upstream frequency spectrum and the downstream frequency spectrum there is provided a guard frequency spectrum separating the upstream and the downstream frequency spectrums.

### CROSS-REFERENCE TO RELATED APPLICATIONS INCORPORATION BY REFERENCE

This application is related to, and claims benefit of and priority from, Provisional Application No. 60/483,221 filed on Jun. 30, 2003 (Attorney Docket No. 1875.4610000), entitled “System And Method For Long Reach Digital Subscriber Line (DSL)”, the complete subject matter of which is incorporated herein by reference in its entirety as if fully set forth herein.

### BACKGROUND OF THE INVENTION

The present invention generally relates to Digital Subscriber Line (DSL) Communication Systems. The present invention relates more particularly to a modem for transmitting data over a DSL communication link, a communication system using a modem, and methods related thereto and used therewith.

In the recent past the demand for high speed data communication services has increased highly. In order to provide such services various x-type digital subscriber line (xDSL) technologies have been developed, the most prevalent of which is the asymmetric digital subscriber line (ADSL) technology. The aforementioned services can be for example high speed internet, broadcast video, video on demand, distance learning and the like.

In most cases the xDSL systems use the public telephone network which in most cases uses simple metallic wire pairs and therefore are heavy band limited. Furthermore often several single communication lines are bundled to trunk lines and so crosstalk between the bundled communication lines can occur which impedes the data transmission. However the present invention can be used for the data transmission over any band limited communication line in any environment.

Referring to FIG. 1, a typical known ADSL system includes a plurality of remote ADSL transceiver units (ATU-R) 1 located at various homes an businesses, and a plurality of complementary central office ADSL transceiver units (ATU-C) 2 located at the telephone company central office. Each ATU-R 1 communicates with each ATU-C over a communication line 3 that may be a single twisted pair line 3. The ATU-R 1 and the ATU-C 2 tipically can support data rates of up to 640 kb/s upstream, i.e. from the ATU-R 1 to the ATU-C 2, and up to 6 Mb/s downstream, i.e. from the ATU-C 2 to the ATU-R 1. Therefore the system is called asymmetric. The ATU-R 1 for example can be connected to computer systems 4, TV set top boxes 5 or any other type of device demanding a broadband connection. Additionally most ADSL and generally xDSL systems support plain old telephone service (POTS). In such cases a POTS splitter 6 is provided to filter out the 4 kHz analog voice signal and route it to an existing analog telephone 7. Alternatively the POTS splitter 6 can be integrated within the ATU-R 1.

At the central office each ATU-C 2 is connected to a digital subscriber line access module (DSLAM) 8. The DSLAM 8 concentrates and/or switches the various data signals and routes them to their appropriate destination, such as an ATM switch 9, an IP router 10 or another broadband device. All of these devices preferably are in turn connected to a broadband network, thereby relieving the problems associated with the transmission of data signals over the public telephone network. If the ADSL system supports plain old telephone service, a POTS splitter 11 is provided to filter out the 4 kHz analog voice signal and to route it to a voice switch 12 of the telephone network. Alternatively the POTS splitter 11 may be integrated within the ATU-C 2.

Although various line coding techniques may be used for the transmission of the data between the ATU-R 1 and the ATU-C 2, a very common technique is the discrete multi tone (DMT) line coding as adopted by the ANSI T1.413 standard.

As shown in FIG. 2, DMT line coding is used to divide the information transmitted over the communication line 3 between 256 subcarriers or tones 13, each of which occupies 4.3125 kHz for a total bandwidth of 1.104 MHz. While most of the subcarriers 13 are use to carry voice and data signals, some are used for network management and performance measurement functions (e.g. tone 64 at 276 kHz is reserved for a downstream pilot signal) and others are not used at all (e.g. those affected by noise or interferences).

As shown in FIG. 3, the 1.104 MHz frequency spectrum is divided into four frequency bands i.e. a voice band 14, guard band 15, an upstream band 16 and a downstream band 17. The voice band 14, which occupies the lower portion of the frequency spectrum between 0 Hz and 4.3125 kHz (i.e. tone 1), is used to carry a 4 kHz analog voice signal. The guard band 15, which occupies the next portion of the frequency spectrum between 4.3125 kHz and 25.875 kHz (i.e. tones 2-6), is used to separate the voice band 14 from the upstream 16 and downstream 17 bands. The upstream band 16 which occupies the next portion of the frequency spectrum between 25.875 kHz and 138 kHz (i.e. tones 7-32) is used to carry data signals from ATU-R 1 to ATU-C₂. The downstream band 17 which occupies the upper portion of the frequency spectrum between 138 kHz and 1.104 MHz (i.e. tones 33-256) is used to carry data signals from ATU-C 2 to ATU-R 1. Thus the ADSL system is capable of providing both POTS and broadband services over the same communication line 3.

The separation of the upstream 16 and the downstream 17 bands into different frequency spectrums has the advantage that echo cancellation is not or nearly not required and therefore the cost for the ATU-R 1 and the ATU-C 2 transmitter can be kept low.

However, xDSL systems have their own problems. One of them is for example due to regulations a limitation of the maximum power that can be applied to the communication line 3 so as to control the transmission of small broadcast signals that can interfere with surrounding signals. Especially because of these power constraints the distance between the ATU-R 1 and the ATU-C 2 is limited due to the attenuation of the signal at the far end and resulting cross-talk from other communication lines. This distance will vary according to the data rate being offered, the gauge and generation of the communication line 3 an other factors. As a result, homes and businesses that are located more away from the central office than a certain distance are not able to receive broadband services above a certain data rate. The range within which xDSL services can be offered therefore is limited.

One known attempt to solve this problem and to extend the range of a xDSL system is to extend the downstream band by the frequency spectrum between 25.875 kHz and 86.25 kHz (i.e. tones 7-20), which however is occupied already by part of the upstream band. Therefore echo cancellation is used in order to enable data transmission in both directions in the same frequency spectrum. This has the disadvantage that the expenses for the xDSL system are increased.

The present invention solves the aforementioned exemplary problems, and/or other problems in the art, and provides a method for transmitting data over a xDSL communication line and a modem for transmitting data over a xDSL communication line with extended range.

### SUMMARY OF THE INVENTION

The present invention relates to a method and a system for transmitting data in a xDSL communication system increasing the range of the communication link. The communication system may consist of any two communication devices that are connected together by a band limited communication line.

According to the present invention in a method for transmitting data in a bidirectional digital subscriber line (xDSL) communication system the communication system comprises a first communication device and a second communication device, both communication devices being connected by a communication line, wherein the first communication device is adapted to send data in upstream direction over the communication line in an upstream frequency spectrum and the second communication device is adapted to send date in downstream direction over the communication line in a downstream frequency spectrum, both communication devices are adapted to receive the data in the send frequency spectrum of the other communication device, and between the upstream frequency spectrum and the downstream frequency spectrum there is provided a guard frequency spectrum separating the upstream and the downstream frequency spectrums.

In one variant the lower one of the upstream or the downstream frequency spectrums at its upper bound has an out-of-band roll-off of at least 9^{th} order. Due to this increased out-of-band roll-off the limitation of the frequency spectrum is sharper and the interference between the two frequency spectrums can be reduced and the range of the communication link and/or the rate of transmitted data can be increased.

In a further variant the bandwidth of the lower one of the upstream or the downstream frequency spectrums is smaller than the upper one of the upstream or the downstream frequency spectrums.

According to yet another variant the level of the signals sent in the lower one of the upstream or the downstream frequency spectrums is higher than in the upper one of the upstream or the downstream frequency spectrums. It is furthermore conceivable that the lower one of the upstream or the downstream frequency spectrums is the upstream frequency band and the power budget of the power spectral density in upstream direction is substantially 12.5 dBm higher than in downstream direction.

Advantageously the data sent in the communication system are coded according to the discrete multi tone (DMT) line coding technique with several tones and the guard frequency spectrum includes at least one tone.

The first communication device can be a remote xDSL transceiver unit located at the subscriber of the xDSL system and the second communication device can be a central office xDSL transceiver unit.

In a preferred embodiment the lower one of the upstream or the downstream frequency spectrums is the upstream frequency spectrum.

The first and/or the second communication device can comprise digital filter means for filtering the sent or received signals. This digital filter means advantageously are programmable and are programmed dependent on control signals transmitted between the first and the second communication devices. The control signals specially can be transmitted during an initializing phase for establishing the communication link between the first and the second communication device.

These and other advantages, aspects and novel features of the present invention, as well as details of illustrated examples, are more fully understood from the following description and drawings.

### BRIEF DESCRIPTION OF THE DRAWINGS

FIG. 1 illustrates a schematic block diagram of an ADSL system,

FIG. 2 illustrates the subcarrier layout of the signals transmitted in the ADSL system of FIG. 1 according to a prior art transmitting scheme,

FIG. 3 shows the frequency spectrum placement of different frequency bands according to the prior art transmission scheme, and

FIG. 4 illustrates the frequency spectrums used for transmission according to the present invention.

### DETAILED DESCRIPTION OF THE INVENTION

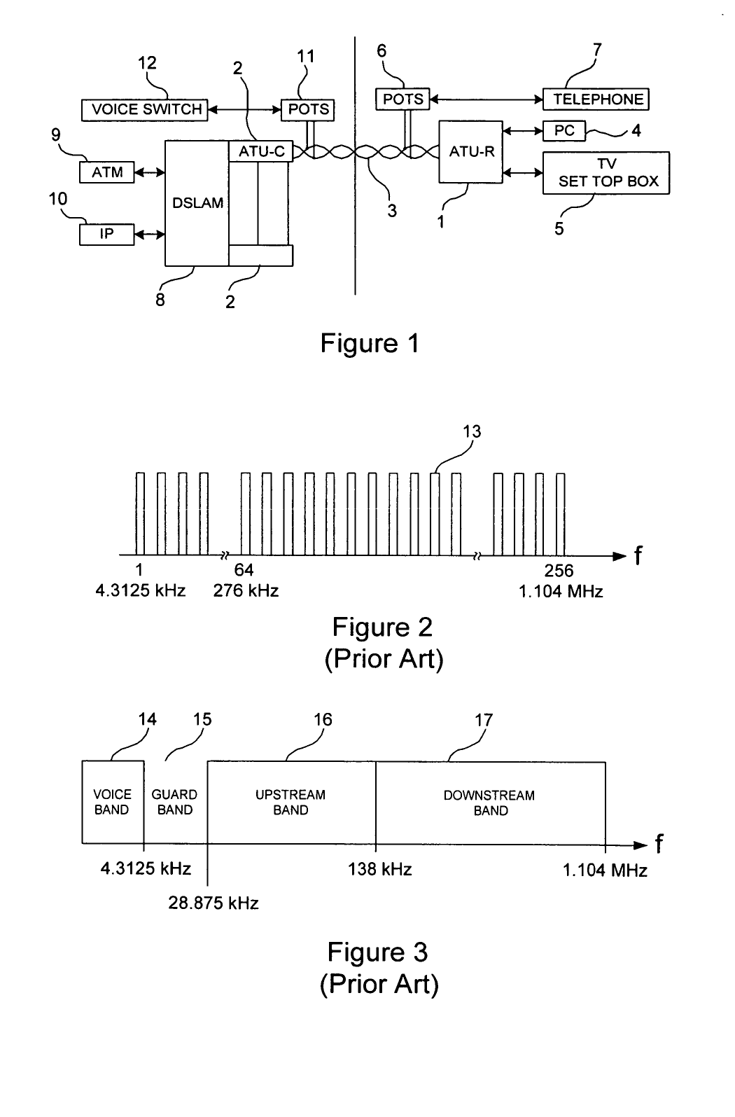

FIG. 1 illustrates an ADSL system which can be used for implementation of the present invention and which has been described in detail before. The ADSL system provides data and voice transmission between a plurality of remote ADSL transceiver units (ATU-R) 1 and a plurality of complementary central office ADSL transceiver units (ATU-C) 2 over a communication line 3 that may be a single twisted pair line 3.

The remote transceiver unit ATU-R 1 and the central transceiver unit ATU-C 2 both comprise a transmitter and a receiver for sending and receiving signals. The transmitters are adapted to send their signals within specified frequency ranges or spectrums respectively and the receivers are adapted to receive signals in the send frequency range of the transmitter the receiver is connected to. The frequency spectrums used by the remote and the central transceiver units are known to both transceiver units so that the each transceiver unit can adapt its receiver.

Additionally ADSL and generally xDSL systems support plain old telephone service (POTS). Therefore a POTS splitter 6 is provided to filter out the 4 kHz analog voice signal and route it to an existing analog telephone 7. Alternatively the POTS splitter 6 can be integrated within the ATU-R 1.

At the central office each ATU-C 2 is connected to a digital subscriber line access module (DSLAM) 8. The DSLAM 8 concentrates and/or switches the various data signals and routes them to their appropriate destination, such as an ATM switch 9, an IP router 10 or another broadband device. All of these devices preferably are in turn connected to a broadband network, thereby relieving the problems associated with the transmission of data signals over the public telephone network. Also in the central office a POTS splitter 11 is provided to filter out the 4 kHz analog voice signal and to route it to a voice switch 12 of the telephone network. Alternatively the POTS splitter 11 may be integrated within the ATU-C 2.

For the transmission of the data between the ATU-R 1 and the ATU-C 2 the discrete multi tone (DMT) line coding as adopted by the ANSI T1.413 standard is used.

As illustrated in FIG. 2 DMT line coding divides the information transmitted over the communication line 3 between 256 subcarriers or tones 13, each of which occupies 4.3125 kHz for a total bandwidth of 1.104 MHz. While most of the subcarriers 13 are use to carry voice and data signals, some are used for network management and performance measurement functions (e.g. tone 64 at 276 kHz is reserved for a downstream pilot signal) and others are not used at all (e.g. those affected by noise or interferences).

A first section of the 1.104 MHz frequency spectrum is used as an upstream frequency spectrum or band for transmitting data in upstream direction from the remote ADSL transceiver units (ATU-R) 1 to the complementary central office ADSL transceiver units (ATU-C) 2. A second other section of the 1.104 MHz frequency spectrum is used as an downstream frequency spectrum or band for transmitting data in downstream direction from the central office ADSL transceiver units (ATU-C) 2 to the complementary remote ADSL transceiver units (ATU-R) 1. Generally a greater amount of data is being transmitted in downstream direction than in upstream direction due to the fact that many applications concern the delivery of audio and video data to the remote end user.

Therefore the downstream frequency spectrum is adapted to allow a higher bandwidth than the upstream frequency spectrum. In order to avoid the necessity for echo cancellation, the upstream frequency spectrum and the downstream frequency spectrums furthermore do not overlap.

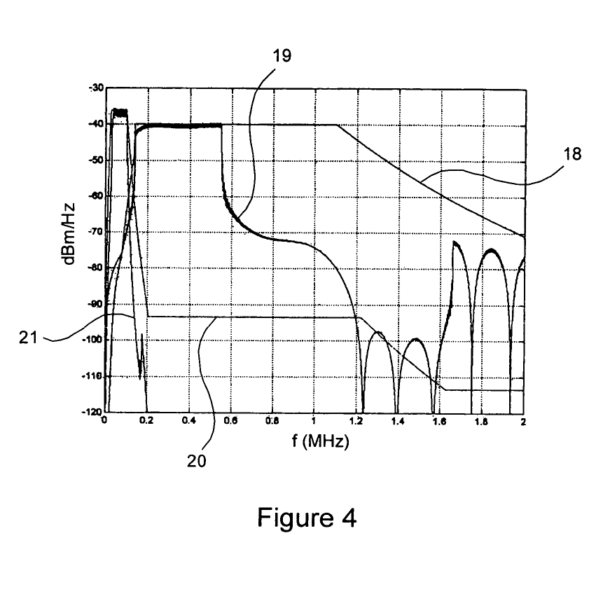

FIG. 4 illustrates the respective frequency ranges of the upstream and the downstream frequency spectrums according to one embodiment of the present invention. The upstream frequency spectrum is limited by the power spectral density graph 20 which indicates the maximum allowable level of the signal transmitted in upstream direction dependent on the frequency. A delimitation of the allowable signal level is specially required since generally several transmission lines 3 are bundled and interferences between the different transmission lines 3 have to be avoided. Graph 21 indicates the signal level in upstream direction of the real system of FIG. 1.

Accordingly the downstream frequency spectrum is limited by the power spectral density graph 18 which indicates the maximum allowable level of the signal transmitted in downstream direction. The bandwidth of the downstream frequency spectrum 18 is larger than of the upstream frequency spectrum 20. Graph 19 indicates the signal level in downstream direction of the real system of FIG. 2.

As can be seen in FIG. 4 there is a gap between the upstream spectrum 21 or the power spectral density graph 20 in upstream direction respectively and the downstream spectrum 19 or the power spectral density graph 18 in downstream direction respectively. Thus there is no overlap of the upstream and downstream spectrums and advantageously no echo cancellation is required.

This gap in first view results in a reduction of the available spectrum in both downstream and upstream direction. But due to this gap the level upstream power spectral density 21 and accordingly the data rate can be increased. The power spectral density 21 in upstream direction for instance can be boosted by 1.85 with respect to conventional ADSL systems, i.e. 36.15 dBm/Hz.

Thus, in terms of data rate the reduced available spectrum substantially can be compensated and the same data rate can be achieved with a simpler ADLS system which does not require echo cancellation.

In the described embodiment it is conceivable that spectrum in upstream and downstream direction is divided in the tones and the gap between the upstream and the downstream spectrums corresponds to one or more unused tones. If for example DMT line coding is used which divides the information transmitted over the communication line 3 between 256 subcarriers or tones 13, each of which occupying 4.3125 kHz for a total bandwidth of 1.104 MHz, then tones 7 to 23 can be used for the upstream spectrum and only tones higher than 31 can be used for the downstream spectrum.

Furthermore the upper stop frequency of the upstream spectrum can be reduced with respect to standard ADLS systems. For example the stop frequency can be 100 kHz compared to the stop frequency of 138 kHz implemented in the conventional ADSL systems.

As described above, the invention provides a method for transmitting data in a bidirectional digital subscriber line (xDSL) communication system and a correspondingly adapted communication system, the communication system comprising a first communication device (1) and a second communication device (2), both communication devices being connected by a communication line (3), wherein the first communication device (1) is adapted to send data in upstream direction over the communication line (3) in an upstream frequency spectrum (20) and the second communication device (2) is adapted to send date in downstream direction over the communication line (3) in a downstream frequency spectrum (18), both communication devices (1, 2) are adapted to receive the data in the send frequency spectrum of the other communication device (2, 1), and between the upstream frequency spectrum (20) and the downstream frequency spectrum (18) there is provided a guard frequency spectrum separating the upstream (20) and the downstream (18) frequency spectrums.

In one variant the lower one of the upstream (20) or the downstream (18) frequency spectrums at it's upper bound has an out-of-band roll-off of at least 9^{th} order. Due to this increased out-of-band roll-off the limitation of the frequency spectrum is sharper and the interference between the two frequency spectrums (18, 20) can be reduced and the range of the communication link and/or the rate of transmitted data can be increased.

In a further variant the bandwidth of the lower one (20) of the upstream (20) or the downstream (18) frequency spectrums is smaller than the upper (18) one of the upstream (20) or the downstream (18) frequency spectrums.

According to yet another variant the level of the signals sent in the lower one (20) of the upstream (20) or the downstream (18) frequency spectrums is higher than in the upper one (18) of the upstream (20) or the downstream (18) frequency spectrums. It is furthermore conceivable that the lower one (20) of the upstream (20) or the downstream (18) frequency spectrums is the upstream frequency band (20) and the power budget of the power spectral density in upstream direction (20) is substantially 12.5 dBm higher than in downstream direction (18).

Advantageously the data sent in the communication system are coded according to the discrete multi tone (DMT) line coding technique with several tones (13) and the guard frequency spectrum includes at least one tone.

The first communication device (1) can be a remote xDSL transceiver unit located at the subscriber of the xDSL system and the second communication device (2) can be a central office xDSL transceiver unit.

In a preferred embodiment the lower one (20) of the upstream (20) or the downstream (18) frequency spectrums is the upstream frequency spectrum (20).

The first (1) and/or the second (2) communication device can comprise digital filter means for filtering the sent or received signals. This digital filter means advantageously are programmable and are programmed dependent on control signals transmitted between the first (1) and the second (2) communication devices. The control signals specially can be transmitted during an initializing phase for establishing the communication link between the first (1) and the second (2) communication device.

Many alterations and modifications may be made by those having ordinary skill in the art without departing from the spirit and scope of the invention. Therefore, it must be understood that the illustrated embodiments have been set forth only for the purposes of example, and that it should not be taken as limiting the invention as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

1. A method for transmitting data in a bidirectional digital subscriber line (xDSL) communication system comprising:
a first communication device and a second communication device, both communication devices being connected by a communication line, wherein the first communication device is adapted to send data in upstream direction over the communication line in an upstream frequency spectrum and the second communication device is adapted to send date in downstream direction over the communication line in a downstream frequency spectrum;
both communication devices are adapted to receive the data in the send frequency spectrum of the other communication device, and
between the upstream frequency spectrum and the downstream frequency spectrum there is provided a guard frequency spectrum separating the upstream and the downstream frequency spectrums.

2. The method of claim 1, wherein the lower one of the upstream or the downstream frequency spectrums at it's upper bound has an out-of-band roll-off of at least 9th order.

3. The method of claim 1, wherein the bandwidth of the lower one of the upstream or the downstream frequency spectrums is smaller than the upper one of the upstream or the downstream frequency spectrums.

4. The method of claim 1, wherein the level of the signals sent in the lower one of the upstream or the downstream frequency spectrums is higher than in the upper one of the upstream or the downstream frequency spectrums.

5. The method of claim 1, wherein the lower one of the upstream or the downstream frequency spectrums is the upstream frequency band and the power budget of the power spectral density in upstream direction is kept constant substantially at 12.5 dBm.

6. The method of claim 1, wherein the data sent in the communication system are coded according to the discrete multi tone (DMT) line coding technique with several tones and the guard frequency spectrum includes at least one tone.

7. The method of claim 1, wherein the first communication device is a remote xDSL transceiver unit located at the subscriber of the xDSL system and the second communication device is a central office xDSL transceiver unit.

8. The method of claim 1, wherein the lower one of the upstream or the downstream frequency spectrums is the upstream frequency spectrum.

9. The method of claim 1, wherein the first and/or the second communication device filters the sent or received signals by means of a digital filter.

10. The method of claim 9, wherein the digital filter is programmable and is programmed dependent on control signals transmitted between the first and the second communication devices.

11. The method of claim 9, wherein the control signals are transmitted during an initializing phase for establishing the communication link between the first and the second communication device.

12. A communication system for transmitting data in a bidirectional digital subscriber line (xDSL), comprising:
a first communication device and a second communication device, both communication devices being connected by a communication line, wherein
the first communication device is adapted to send data in upstream direction over the communication line in an upstream frequency spectrum and the second communication device is adapted to send date in downstream direction over the communication line in a downstream frequency spectrum;
both communication devices are adapted to receive the data in the send frequency spectrum of the other communication device, and
between the upstream frequency spectrum and the downstream frequency spectrum there is provided a guard frequency spectrum separating the upstream and the downstream frequency spectrums.

13. The communication system of claim 12, wherein the lower one of the upstream or the downstream frequency spectrums at it's upper bound has an out-of-band roll-off of at least 9th order.

14. The communication system of claim 12, wherein the bandwidth of the lower one of the upstream or the downstream frequency spectrums is smaller than the upper one of the upstream or the downstream frequency spectrums.

15. The communication system of claim 12, wherein the level of the signals sent in the lower one of the upstream or the downstream frequency spectrums is higher than in the upper one of the upstream or the downstream frequency spectrums.

16. The communication system of claim 12, wherein the lower one of the upstream or the downstream frequency spectrums is the upstream frequency band and the power budget of the power spectral density in upstream direction is kept constant substantially at 12.5 dBm.

17. The communication system of claim 12, wherein the data sent in the communication system are coded according to the discrete multi tone (DMT) line coding technique with several tones and the guard frequency spectrum includes at least one tone.

18. The communication system of claim 12, wherein the first communication device is a remote xDSL transceiver unit located at the subscriber of the xDSL system and the second communication device is a central office xDSL transceiver unit.

19. The communication system of claim 12, wherein the lower one of the upstream or the downstream frequency spectrums is the upstream frequency spectrum.

20. The communication system of claim 12, wherein the first and/or the second communication device filters the sent or received signals by means of a digital filter.

21. The communication device of claim 20, wherein the digital filter is programmable and is programmable dependent on control signals transmitted between the first and the second communication devices.

22. The communication device of claim 21, wherein the control signals are transmitted during an initializing phase for establishing the communication link between the first and the second communication device.
